(19) United States
(12) Patent Application Publication
(10) Pub. No.: US 2023/0223610 A1
(43) Pub. Date: Jul. 13, 2023

(54) METHOD FOR SELECTIVELY SEPARATING A CARBON-CONTAINING MATERIAL FROM A MIXTURE OF POSITIVE ELECTRODES AND NEGATIVE ELECTRODES

(71) Applicants: COMMISSARIAT À L'ÉNERGIE ATOMIQUE ET AUX ÉNERGIES ALTERNATIVESÉ, Paris (FR); ORANO, Chatillon (FR)

(72) Inventors: Emmanuel Billy, Grenoble (FR); Sandrine Barthelemy, Grenoble (FR)

(21) Appl. No.: 18/000,059

(22) PCT Filed: May 27, 2021
(86) PCT No.: PCT/FR2021/050960

§ 371 Date: Nov. 28, 2022

(30) Foreign Application Priority Data
May 29, 2020 (FR) FR2005708

(51) Int. Cl. H01M 10/54; B09B 3/80; B09B 3/70; B09B 3/35; C01B 32/215

(52) U.S. Cl. CPC H01M 10/54; B09B 3/80; B09B 3/70; B09B 3/35; C01B 32/215; B09B 2101/16

(57) ABSTRACT

A method for selectively separating a carbon-containing material from a mixture comprising a positive electrode and a negative electrode originating from electrochemical cells and/or accumulators, the method comprising the following successive steps: a) providing a mixture comprising a positive electrode and a negative electrode, each electrode comprising a current collector, an active material and a binder, the active material of the negative electrode being a carbon-containing material, preferably graphite, b) contacting the mixture comprising the positive electrode and the negative electrode with a separation solution, in the presence of ultrasound, the separation solution comprising a solvent and, optionally, additives, until selectively separating the carbon-containing material from the current collector of the negative electrode, the active material of the positive electrode remaining secured to the current collector of the positive electrode.

### TECHNICAL FIELD

The present invention relates to the general field of recycling electrochemical generators (cells, accumulators or batteries), for example, lithium electrochemical generators and, more particularly, to the recycling of batteries of the Li-ion type.

The invention relates to a separation method allowing selectively separating the carbon-containing active material from a mixture of positive electrodes and negative electrodes originating from electrochemical generators.

The invention is particularly interesting since it not only allows selectively separating the carbon-containing active material (such as graphite) from the other active materials (in particular the lithium mixed oxides present on the positive electrode) but also from the negative current collectors. It is thus possible to directly valorise the carbon-containing active material of the negative electrode and the current collector thereof. In addition, it is thus possible to recover, subsequently, a positive active material powder of high purity.

### STATE OF THE PRIOR ART

The market for lithium accumulators (or batteries), in particular of the Li-ion type, is now experiencing strong growth, in particular with the development of nomadic applications (“smartphones”, power tools, etc.) and with the emergence of electric and hybrid vehicles.

The lithium-ion accumulators comprise an anode, a cathode, a separator, an electrolyte and a casing which can be a polymer pocket, or a metal packaging. The negative electrode generally comprises graphite, mixed with a binder of the carboxymethylcellulose (CMC) or polyvinylidene fluoride (PVDF) type, and deposited on a copper foil acting as a current collector. The positive electrode is a lithium ion insertion material (in particular, it is a metal oxide such as, for example, LiCoO₂, LiMnO₂, Li₃NiMnCoO₆, LiFePO₄), mixed with a graphite and polyvinylidene fluoride binder, and deposited on an aluminium foil acting as a current collector. The electrolyte consists of lithium salts (LiPF₆, LiBF₄, LiCF₃SO₃, LiClO₄) which are solubilised in an organic base consisting of mixtures of binary or ternary solvents based on cyclic carbonates (ethylene carbonate, propylene carbonate, butylene carbonate), linear or branched (dimethyl carbonate, diethyl carbonate, ethyl methyl carbonate, dimethoxyethane) in various proportions.

The operation is as follows: during charging, the lithium is deintercalated from the active material of the positive electrode and is inserted into the active material of the negative electrode. During discharging, the process is reversed.

Given the environmental, economic and strategic issues related to the procurement of certain metals present in batteries, it is necessary to recycle at least 50% of the materials contained in the Li-ion batteries and accumulators (directive 2006/66/EC).

In particular, it involves recycling and valorising elements originating from the current collectors (copper, aluminium) and the active material (the carbon-containing material and the metal oxides) of the electrodes.

During the recycling method, the pre-treatment steps are fundamental because they condition the amount of active materials of positive electrodes which can then be treated via hydrometallurgical route. We seek to obtain the most concentrated fraction possible in metals is sought to be obtained while minimising the amount of impurities.

It is therefore essential to separate graphite and/or the metal oxides (nickel, cobalt, manganese metals, etc.) from the metal current collectors (typically aluminium and copper). This allows, on the one hand, having a powder (“black mass”) which is more concentrated in metal oxides for the hydrometallurgy step, which reduces contamination, and on the other hand, increasing the number and the amount of recovered products, which improves the recycling rate.

The separation of the current collectors (Cu, Al) from the insertion materials (carbon, metal oxides) is generally obtained by thermal and/or mechanical means.

For example, a heat treatment at 500° C. degrades the binder of the electrode. Grinding and sieving steps can then be carried out to recover the elements of higher value. However, the method generates toxic gases and consumes carbon with the formation of CO₂.

The mechanical separation, in turn, has a major drawback: it does not allow completely separating all components of the batteries, because certain compounds (metals, organic substances, inorganic substances) penetrate into each other, generating a complex mixture whose different constituents are difficult to separate.

One of the most promising routes is the chemical route because it allows the dissolution of the current collectors in an aqueous medium and/or the dissolution of the binders (CMC, PVDF, etc.). However, the dissolution of the collectors in aqueous media requires large amounts of acids and/or concentrated acids. In addition, this leads to impurities in the hydrometallurgical method. The binder dissolution requires organic solvents (N-Methyl-2-pyrrolidone (NMP), N-N dimethyl formamide (DMF), N-dimethyl acetamide (DMAC) or dimethyl sulfoxide (DMSO)), which has risks and dangers for humans and the environment.

In order to overcome these drawbacks, the research has turned to the ionic liquids which are stable under atmospheric conditions (absence of reactions leading to the formation of hydrofluoric acid).

For example, by using an ionic liquid [BMIM][BF₄] heated to 180° C. with stirring at 300 rpm, it is possible to melt a PVDF binder and thus separate an aluminium collector from a cathode material. Under these treatment conditions, the separation efficiency of the aluminium collector from the active material LiCoO₂ is 99% for a treatment of 25 min [1]. However, the treatment has several drawbacks: it must be carried out at a very significant temperature of 180° C. and the use of an anion of the BF₄⁻ type is harmful for a use in ambient atmosphere because it is degraded by hydrolysis with water, and forms hydrofluoric acid. In addition, it is necessary to separately treat the positive and negative electrodes, which increases the number of steps of the battery recycling method.

In order to overcome these drawbacks, another solution consists in simultaneously treating the positive and negative electrodes of the lithium-ion batteries in a polar solvent [2]. Pieces of anode and cathode are immersed, for example in water or alcohol, with mechanical stirring for a period of 15 minutes to 10 hours in order to dissolve the binder of the electrodes. The stirring can be carried out with ultrasound. The method allows separating the active materials from the anode and the cathode of the current collectors. However, this method is not selective since the active materials of the two electrodes are found in solution mixture. The particle size of these materials being similar, their separation requires the implementation of methods which are complex, inefficient and which generate effluents.

### DISCLOSURE OF THE INVENTION

A purpose of the present invention is to propose a method allowing selectively separating the carbon-containing material from a mixture comprising a positive electrode and a negative electrode, the method having to be able to be implemented at reasonable temperatures (typically less than 160° C.).

For this, the present invention proposes a method for selectively separating a carbon-containing material from a mixture comprising a positive electrode and a negative electrode originating from electrochemical cells and/or accumulators comprising the following successive steps:

a) providing a mixture comprising a positive electrode and a negative electrode, each electrode comprising a current collector, an active material and a binder, the active material of the negative electrode being a carbon-containing material, preferably graphite,

b) contacting the mixture comprising the positive electrode and the negative electrode with a separation solution, in the presence of ultrasound, the separation solution comprising a solvent and, optionally, additives, until selectively separating the carbon-containing material from the current collector of the negative electrode, the active material of the positive electrode remaining secured to the current collector of the positive electrode.

“Mixture comprising a positive electrode and a negative electrode” means that the mixture comprises at least one positive electrode and at least one positive electrode. Preferably, the mixture comprises several positive electrodes and several negative electrodes.

“Positive electrode” (also called cathode) means the electrode which is the seat of an oxidation during charging and which is the seat of a reduction during discharging.

“Negative electrode” (also called anode) means the electrode which is the seat of a reduction during charging and which is the seat of an oxidation during discharging.

“Selective separation” means that, at the end of step b), the active material is peeled from the current collector of the negative electrode and is found in solution while the active material remains on the positive current collector of the positive electrode.

The separation step takes place without dissolution of the binder when it is present, without degradation of the medium and/or consumption of the reagents, while avoiding the gas release. In addition, there is no need to separate the electrodes beforehand, which simplifies the method for recycling a battery.

The peeling/exfoliation of the carbon-containing material from the negative current collector, by immersion in the separation solution, is carried out over a very short time (typically less than 1 hour, or even less than or equal to 30 minutes) and for low temperatures (typically less than or equal to 150° C., and preferably less than 80° C.).

The separation solution is a stable solution under atmospheric conditions (in particular, absence of reactions leading to the formation of HF).

According to a first advantageous variant, the separation solution is an aqueous solution and the solvent is water. Advantageously, the pH of the separation solution is between 6 and 7.

According to a second advantageous variant, the separation solution is an alcoholic solution and the solvent is an alcohol.

According to a third advantageous variant, the separation solution is an ionic liquid solution and the solvent is a solvent ionic liquid. For example, the ionic liquid solution comprises a solvent ionic liquid and, optionally, one or more additional ionic liquids.

Advantageously, the solvent ionic liquid comprises a cation selected from one of the following families: imidazolium, pyrrolidinium, ammonium, piperidinium and phosphonium.

Advantageously, the solvent ionic liquid comprises an anion selected from halides, bis(trifluoromethanesulfonyl)imide (CF₃SO₂)₂N⁻ denoted TFSI⁻, bis(fluorosulfonyl)imide (FSO₂)₂N⁻ denoted FSI⁻, trifluoromethanesulfonate or triflate denoted CF₃SO₃⁻, tris(pentafluoroethyl)trifluorophosphate denoted FAP⁻ and bis(oxalato)borate anions denoted BOB⁻.

Even more advantageously, the anion is a chloride, in combination with an ammonium or phosphonium cation. The solvent ionic liquid is, preferably [P66614][Cl].

Advantageously, the ionic liquid solution forms a deep eutectic solvent.

Advantageously, the deep eutectic solvent is a mixture of choline chloride and ethylene glycol.

The separation solution can also comprise several solvents: it can be a mixture of water/alcohol, alcohol/ionic liquid or water/ionic liquid in different proportions.

Advantageously, step b) is carried out at a temperature ranging from 20° C. to 150° C., and preferably from 20° C. to 80° C., and even more preferably from 20° C. to 40° C. The peeling step can be activated in temperature.

Advantageously, step b) is carried out for a period ranging from 1 min to 1 hour, preferably from 1 min to 30 min and even more preferably between 1 min and 25 min.

Advantageously, the power of ultrasound ranges from 0.5 to 16 kW.

Advantageously, the ultrasound frequency is between 16 KHz and 500 KHz per litre of separation solution and preferably between 16 KHz and 50 KHz per litre of separation solution.

Advantageously, the power ranges from 0.01 kW/m³/h to 10 kW/m³/h of separation solution and preferably from 0.5 kW/m³/h to 5 kW/m³/h of separation solution. In a particularly advantageous manner, such power ranges are associated with a frequency ranging from 18 to 20 KHz per litre of solution.

Advantageously, a frequency comprised between 16 and 100 KHz, preferentially between 20 and 50 KHz, with a power called acoustic power comprised between 1.10⁻³ W/mL and 10 W/mL, and preferentially between 0.5 W/mL and 0.01 W/mL, are selected.

Preferably, the solid to liquid ratio is comprised between 1 and 30% and preferably between 5 and 15%. The solid corresponds to the total mass (kg) of positive electrode and negative electrode and the liquid to the volume (L) of the separation solution.

Advantageously, the current collector of the positive electrodes is made of aluminium and/or the current collector of the negative electrodes is made of copper.

Advantageously, the additives are flotation agents selected from kerosene, n-dodecane and methyl isobutyl carbinol (MBIC).

The method has many advantages:
an economic and environmental gain by selectively separating the carbon-containing active material from the other active materials by a simple peeling,
subsequent recovery of a pure metal oxide powder from the positive electrode (“black mass”) which can be retreated to directly form new cathode materials (short route), avoiding and/or reducing the hydrometallurgy steps, which increases economic and environmental gains,
recovery of the carbon-containing active material (in particular graphite) for a new use, increasing the recycling rate and thus the viability of the method,
a low implementation temperature,
a selective separation of the different elements without dissolving the current collectors and/or the binder, which avoids contamination,
a selective separation of the carbon-containing active material without degrading the medium,
avoiding the gas releases, which makes the method safer,
the method is simple and quick to implement,
the method avoids the consumption of reagent and the retreatment of the solutions (effluents),
the method can operate in a closed circuit.

The invention also relates to a method for recycling a battery comprising the following successive steps:
providing a battery, comprising an organic electrolyte, a positive electrode and a negative electrode, each electrode comprising a current collector, an active material and a binder, the active material of the negative electrode being a carbon-containing material, preferably graphite,
dismantling, securing and cutting the battery, so as to obtain a mixture comprising an organic electrolyte, a positive electrode and a negative electrode,
washing (contacting) the mixture with a solution, preferably aqueous solution, in the presence of ultrasound, so as to remove the organic electrolyte from the positive electrode and the negative electrode and to selectively separate the carbon-containing material from the current collector of the negative electrode, the active material of the positive electrode remaining secured to the current collector of the positive electrode.

The washing step follows the discharging and cutting of the batteries. It allows removing the organic electrolyte (carbonates and lithium salts) from the chips derived from the cutting in order to purify them and remove the risks related to the electrolyte (ignition, generation of HF . . . ).

In this method, the step of selective separation of the active material from the negative electrode is advantageously coupled with the operation of washing the batteries. Thus, it is possible to simultaneously selectively remove graphite and improve the washing operation.

Other features and advantages of the invention will emerge from the following additional description.

It is obvious that this additional description is only given by way of illustration of the object of the invention and should in no way be interpreted as a limitation of this object.

### BRIEF DESCRIPTION OF THE DRAWINGS

The present invention will be better understood on reading the description of exemplary embodiments given for illustrative purposes only and without limitation, with reference to the appended drawings in which:

FIG. 1 is a photographic print representing a mixture of positive and negative electrodes of a Li-ion battery (18650 SAMSUNG cell) after treatment in an aqueous medium at 30° C. under ultrasound, after implementing a particular embodiment of the method according to the invention,

FIG. 2 is a photographic print representing a mixture of positive and negative electrodes of a Li-ion battery (SONY KONION 18650 cell) after treatment in an aqueous medium at 30° C. under ultrasound, after implementing a particular embodiment of the method according to the invention,

FIG. 3 a photographic print representing a mixture of positive and negative electrodes of a Li-ion battery (SAMSUNG 18650 cell) after treatment in an ethaline ionic liquid medium at 30° C. under ultrasound, after implementing a particular embodiment of the method according to the invention,

FIG. 4 is a photographic print representing a mixture of positive and negative electrodes of a Li-ion battery (SONY KONION 18650 cell) after treatment in an ethaline ionic liquid medium at 30° C. under ultrasound, after implementing a particular embodiment of the method according to the invention,

FIG. 5 is a photographic print representing a mixture of positive electrodes and negative electrodes of a CATL prismatic Li-ion type battery after treatment in an aqueous medium at 30° C. under ultrasound, after implementing a particular embodiment of the method according to the invention,

FIG. 6 is a photographic print representing a mixture of positive electrodes and negative electrodes of a CATL prismatic Li-ion type battery after treatment in an aqueous liquid medium at 30° C. under ultrasound, after implementing a particular embodiment of the method according to the invention.

### DETAILED DISCLOSURE OF PARTICULAR EMBODIMENTS

Although this is in no way limiting, the invention particularly finds applications in the field of recycling and/or valorising the electrodes of batteries/accumulators/cells of the Li-ion type.

The method for selectively separating allows separating the carbon-containing active material from a mixture comprising at least one positive electrode and at least one negative electrode. Preferably, the mixture comprises several positive electrodes and several negative electrodes.

The method comprises the following successive steps:

a) providing a mixture of positive electrodes and negative electrodes, each electrode comprising a current collector, an active material and a binder, the active material of the negative electrode being a carbon-containing material, preferably graphite,

b) contacting the mixture of positive electrodes and negative electrodes with a separation solution, in the presence of ultrasound, the separation solution comprising a solvent and, optionally, additives, until selectively separating the carbon-containing material from the negative electrodes, the active material of the positive electrodes remaining secured to the current collector of the positive electrodes.

The positive electrodes can be identical or different. The negative electrodes can be identical or different. The electrodes can originate, for example, from a cell and/or an accumulator.

The active material of the negative electrode is a carbon-containing material, for example, graphite. The current collector may be a copper foil.

The active material of the positive electrode is a lithium ion insertion material. It can be a lamellar oxide of the LiMO₂ type, a phosphate LiMPO₄ with an olivine structure or even a spinel compound LiMn₂O₄. M represents a transition metal. LiCoO₂, LiMnO₂, LiNiO₂, Li₃NiMnCoO₆, or LiFePO₄ will be selected, for example. It is deposited on a current collector, for example, an aluminium foil.

The active material of the electrodes is preferably mixed with a polymer binder, for example of the polyvinylidene fluoride type (PVDF) or of the carboxymethylcellulose (CMC) type.

The largest dimension of the positive electrodes and/or of the negative electrodes is, for example, between 0.05 cm and 50 cm, and preferably between 0.5 and 20 cm.

During step b), the electrodes are for example immersed in the separation solution.

The electrodes are at least partially immersed and are preferably completely immersed in the ionic liquid solution.

The electrodes can be attached to another element or float in the separation solution.

The separation solution (also called peeling solution) allows separating, from the negative current collector, the negative active material in the form of particles and stabilising these particles while preventing their dissolution. It is also possible to separate the active material in the form of a block of particles whose cohesion can be ensured by the binder.

“Particles” means elements, for example, of spherical, elongated, or ovoid shape. They can have a larger dimension of less than 200 μm, for example ranging from 2 nm to 20 μm. In the case of spherical particles, it is the diameter. This size can be determined by dynamic light scattering (DLS).

The separation solution is an aqueous solution, an ionic liquid solution, an alcoholic solution or a mixture thereof in various proportions.

The pH of the aqueous solution is preferably a neutral pH (less than or equal to 7). A pH ranging from 6 to 7 (limits included) will be selected, for example. Preferably, the aqueous solution contains a single solvent (water).

The ionic liquid solution can comprise one or more ionic liquids. “Ionic liquid” means the association of at least one cation and at least one anion which generates a liquid with a melting temperature below or close to 100° C. the ionic liquids are solvents which are non-volatile and non-flammable and chemically stable at temperatures above 200° C.

The ionic liquid solution comprises at least one ionic liquid called solvent ionic liquid. “Solvent ionic liquid” means an ionic liquid which is thermally and chemically stable, minimising an effect of degradation of the medium during the peeling phenomenon.

The ionic liquid solution can also comprise one or more (two, three for example) additional ionic liquids, that is to say that it comprises a mixture of several ionic liquids. The additional ionic liquid(s) (LI2, LI3, etc.) have an advantageous role relative to the separation step and in particular relative to one or more properties of: viscosity, solubility, hydrophobicity, melting temperature and bath stability (avoids toxic gases such as HF . . . ).

The cation of the solvent ionic liquid is preferably selected from one of the following families: imidazolium, pyrrolidinium, ammonium, piperidinium and phosphonium.

Preferably, it is a cation with low environmental impact and low cost. Advantageously, an ammonium or phosphonium cation will be selected. Advantageously, the cation can be selected from the group consisting of a tetraalkylammonium, an N,N-dialkylimidazolium, an N,N-dialkylpyrrolidinium, a tetraalkylphosphonium, a trialkylsulfonium and an N,N-dialkylpiperidinium.

In particular, phosphonium cations are stable and facilitate the extraction of the active material in particulate form.

More advantageously, a cation having C₂-C₁₄ alkyl or fluoro-alkyl chains will be selected, typically the cation [P66614]⁺ (trihexyltetradecyl-phosphonium).

The cation of the solvent ionic liquid is associated with an anion which is either organic or inorganic, preferably having a low environmental impact and a low cost. Advantageously, anions will be used allowing obtaining at least one, and preferably all, of the following properties:
a moderate viscosity,
a low melting temperature (liquid at ambient temperature),
not leading to the hydrolysis (degradation) of the ionic liquid,
not leading to the degradation of the electrolyte of the battery.

Preferably, the anion of the solvent ionic liquid has little or no complexing affinity. The anion is, for example, selected from halides, bis(trifluoromethanesulfonyl)imide (CF₃SO₂)₂N⁻ denoted TFSI⁻, bis(fluorosulfonyl)imide (FSO₂)₂N⁻ denoted FSI⁻, trifluoromethanesulfonate or triflate denoted CF₃SO₃⁻, tris(pentafluoroethyl)trifluorophosphate denoted FAP⁻ and bis(oxalato)borate anions denoted BOB⁻.

Preferably, the chloride anion is selected, for example, in combination with an ammonium or phosphonium cation. By way of illustration, the solvent ionic liquid trihexyltetradecylphosphonium chloride denoted [P66614][Cl] can be used.

Among the different possible combinations, preference will be given to a low-cost environment with a low environmental impact (biodegradability).

It is thus possible to select a medium which is non-toxic, having a high biodegradability and being even able to be used as a food additive.

For example, an ionic liquid forming a deep eutectic solvent (or DES) will be selected. It is a liquid mixture at ambient temperature obtained by forming an eutectic mixture of 2 salts, of general formula:

[Cat]⁺,[X]⁻, z[Y]

With:

[Cat]⁺ is the cation of the solvent ionic liquid (for example ammonium),

[X]⁻ a halide anion (for example Cl⁻),

[Y] a Lewis or Brönsted acid which can be complexed by the X⁻ anion of the solvent ionic liquid, and z the number of Y molecules.

For example, DES is choline chloride in combination with a H-bond donor of a very low toxicity, such as ethylene glycol, glycerol or urea, which guarantees a non-toxic and very low-cost DES. According to another exemplary embodiment, the choline chloride can be replaced by betaine.

Optionally, the separation solution may comprise a drying agent, and/or an agent promoting the transport of material and/or a flotation agent ensuring the flotation of the carbon-containing material.

The anhydrous desiccating agent can be a salt not intervening in the reactions at the electrodes and not reacting with the solvent, for example MgSO₄, Na₂SO₄, CaCl₂, CaSO₄, K₂CO₃, NaOH, KOH or CaO.

The agent promoting the material transport is, for example, a fraction of a co-solvent which can be added to reduce the viscosity, such as water. An organic solvent can also be introduced and, more advantageously, the battery electrolyte residues can be used as a co-solvent (carbonate-based medium) to effectively lower the viscosity without generating risks relative to the peeling and increase the battery recycling rate. In a non-exhaustive manner, mention may be made of vinylene carbonate (VC), gamma-butyrolactone (γ-BL), propylene carbonate (PC), poly(ethylene glycol), dimethyl ether. The concentration of the agent promoting the material transport advantageously ranges from 0.1% to 15% and more advantageously from 1% to 5% by mass.

The flotation agent increases the selectivity of separation between the small carbon particles which will rise to the surface and the rest of the material which will remain in suspension.

According to a first variant, the flotation agent can be a reagent called “collector”, advantageously used in combination with a bubbling in the solution.

According to another variant, the flotation agent can be a reagent called “foaming agent”.

The chemical reagent called “collector” is a surfactant. It is a heteropolar organic molecule comprising at least one hydrocarbon chain and one polar head, and optionally one or more easily ionisable groups. The collector is added to make the surface of the carbon-containing material to be floated hydrophobic, in order to give it a greater affinity for the gas phase than for the liquid phase. The particles made hydrophobic are attached to the surface of the bubbles which act as a transport vector thanks to their upward movement towards the free surface of the solution. A supernatant foam loaded with carbon-containing material is thus obtained. The used collector is preferably kerosene or n-dodecane.

The foaming agent is a surfactant molecule. Preferably, it is a heteropolar organic molecule belonging to alcohols. Preferably, 4-methyl-2-pentanol (or MBIC for methyl isobutyl carbinol) will be selected.

Alternatively, the ionic liquid can act as a foaming agent or collector depending on the considered medium.

Step b) is carried out under ultrasound. The ultrasonic activation allows significantly reducing the temperature and/or the time required to fully peel the carbon-containing active material from the current collector.

Preferably, the ultrasound frequency is between 16 KHz and 500KHz per litre of separation solution and preferentially between 16 KHz and 50 KHz per litre of separation solution.

Preferably, the power of the ultrasounds is comprised between 0.5 and 16 kW. For example, the power ranges from 0.01 kW/m³/h to 10 kW/m³/h of separation solution and preferably from 0.5 kW/m³/h to 5 kW/m³/h of separation solution.

The ratio between the total mass of positive electrode(s) and negative electrode(s) to the volume of separation solution is, advantageously, comprised between 0.01% and 30% and more preferably between 0.01% and 15%.

According to an advantageous embodiment, the ratio between the total mass of positive electrode(s) and negative electrode(s) to the volume of separation solution is comprised between 0.1 g/L (i.e. 0.01%) and 50 g/L (i.e. 5%) and more advantageously between 1 g/L (i.e. 0.1%) and 25 g/L (i.e. 2.5%).

The duration of step b) will be estimated according to the nature of the solution, but also according to the dimensions of the ground material (chips) of the cells and accumulators. A sufficient time will be chosen for a complete peeling of the carbon. Advantageously, step b) is carried out for a period ranging from 1 minute to 1 hour, and preferably from 1 min to 30 min.

When the separation solution is an ionic liquid solution, the temperature of the mixture is preferably less than 160° C., and even more preferably less than 150° C. It ranges, for example, from 20° C. to 150° C., preferably from 20° C. to 80° C., even more preferably from 20° C. to 60° C.

When the separation solution is an aqueous solution, the temperature of the mixture is preferably lower than 100° C., and even more preferably less than 90° C. It ranges, for example, from 20° C. to 80° C., and preferably from 20° C. to 60° C.

Step b) can be carried out under air or under an inert atmosphere such as, for example, under argon or nitrogen.

A stirring, for example between 50 rpm and 2000 rpm, can be carried out. This speed will be adjusted depending on the used separation solution. Preferably, the stirring ranges from 100 rpm to 800 rpm.

The method for recycling the electrode can be implemented in a method for recycling cells and/or accumulators and/or batteries.

For example, in the case of a battery, the recycling method may comprise the following steps: sorting, dismantling of the battery, securing (for example discharging, opening), physical (cutting, manual separation . . . ) and/or chemical (electrolyte washing . . . ) pre-treatment, implementation of the previously described selective separation method.

The washing operation consists in removing the organic electrolyte (carbonates and lithium salts) from the chips in order to purify the material and remove the risks related to the electrolyte (ignition, generation of HF . . . ).

According to a particular embodiment, the washing step is carried out before the selective separation method.

According to another particular embodiment, the selective separation method can be coupled with the washing operation to simultaneously selectively remove the carbon-containing active material and the electrolyte residues. The washing operation is thus improved.

This recycling method can further comprise a subsequent step during which conventional techniques are carried out (pyrometallurgy and/or hydrometallurgy . . . ) to recover and valorise the different components, and mainly, the active material (metal oxide).

The method can also comprise a step for recycling the purified metal oxide powder by cathode material regeneration routes, without the need to carry out a hydrometallurgy step (short route).

### Illustrative and Non-Limiting Examples of an Embodiment

### Example 1: Selective Peeling of Graphite from a Mixture of Electrodes in an Aqueous Medium Under Stirring and Ultrasonic Activation

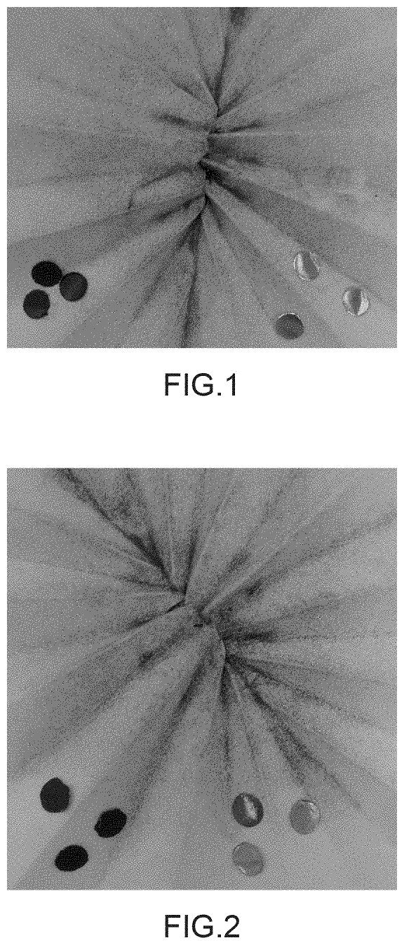

A SAMSUNG 18650 Li-ion type cell is previously discharged, opened and then dried. The positive electrode, formed of an aluminium collector and active materials of the Li(NiMnCo)_{1/3}O₂ type, as well as the negative graphite electrode is removed manually. Then, 3 pads of each electrode are prepared. The separation solution (50 mL) is an aqueous solution having a pH between 6 and 7, at the temperature of 30° C. The solution is stirred at 200 rpm. The six pads are immersed in the solution then a 23 KHz ultrasound probe is actuated at 80% of its power continuously. After 1 minute of treatment, the peeling of graphite from the negative electrode is complete. The copper is free of particles and without presence of corrosion on the surface. The active material (Li(NiMnCo)_{1/3}O₂)) of the positive electrode is intact and remains completely present on the aluminium surface. After filtration, the carbon powder, which can be easily recovered by sieving, is observed in the filter (FIG. 1).

### Example 2: Selective Peeling of Graphite from a Mixture of Electrodes in an Aqueous Medium Under Stirring and Ultrasonic Activation

A SONY KONION 18650 Li-ion type cell is previously discharged, opened and dried. The positive (aluminium and active materials of the Li(NiMnCo)_{1/3}O₂ type) and negative (graphite) electrodes are removed manually. Then, three pads per (positive, negative) electrode are immersed in a separation solution. The separation solution (50 mL) is an aqueous solution (pH between 6 and 7) at the temperature of 30° C. with stirring at 200 rpm. The six pads are introduced then the 23 KHz ultrasound probe is actuated at 80% of its power continuously. After 2 minutes of treatment, the peeling of graphite is complete. The copper is free of particles and without presence of corrosion on the surface, while the active material (Li(NiMnCo)_{1/3}O₂) of the positive electrode is intact and remains completely present on the aluminium surface (FIG. 2). In the filter, the carbon powder, which can be easily recovered by sieving, is observed.

### Example 3: Selective Peeling of Graphite from a Mixture of Electrodes in an Ethaline Ionic Liquid Medium Under Stirring and Ultrasonic Activation

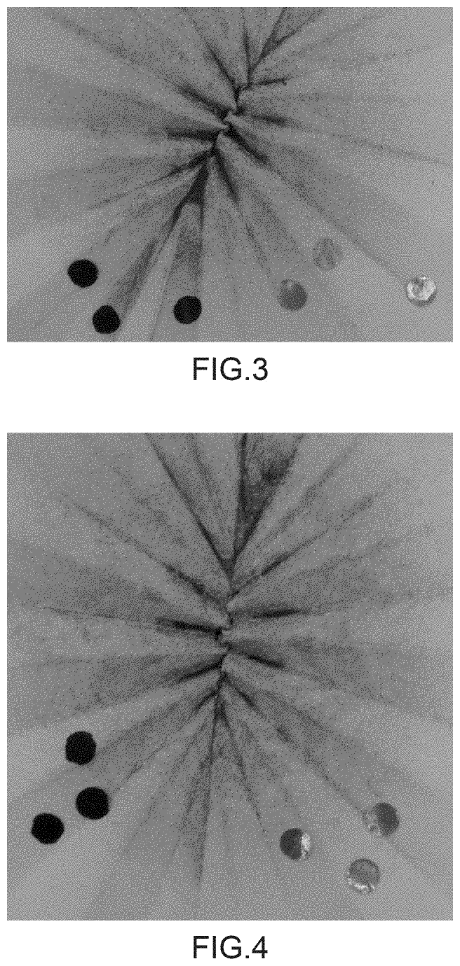

A SAMSUNG 18650 Li-ion type cell is previously discharged, opened and then dried. The positive electrodes (aluminium and active materials of the Li(NiMnCo)_{1/3}O₂ type) and the negative electrodes (graphite) are removed manually. Then, three pads per electrode are immersed in a separation solution based on the Ethaline ionic liquid. The Ethaline solution has a volume of 50 mL and the bath temperature is 30° C. with stirring at 200 rpm. The six pads are introduced then the 23 KHz ultrasound probe is actuated at 80% of its power continuously. After 4 minutes of treatment, the peeling of graphite is complete. The copper is free of particles and without presence of corrosion on the surface, while the active material (Li(NiMnCo)_{1/3}O₂) of the positive electrode is intact and remains completely present on the aluminium surface (FIG. 3). In the filter, the carbon powder, which can be easily recovered by sieving, is observed.

### Example 4: Selective Peeling of Graphite from a Mixture of Electrodes in an Ethaline Ionic Liquid Medium Under Stirring and Ultrasonic Activation

A SONY KONION 18650 Li-ion type cell is previously discharged, opened and then dried. The positive electrodes (aluminium and active materials of the Li(NiMnCo)_{1/3}O₂ type) and the negative electrodes (graphite) are removed manually. Then three pads of each electrode are immersed in the separation solution based on the Ethaline ionic liquid. The Ethaline solution has a volume of 50 mL and the bath temperature is 30° C. with stirring at 200 rpm. The six pads are introduced, then the 23 KHz ultrasound probe is actuated at 80% of its power continuously. After 10 minutes of treatment, the peeling of graphite is complete. The copper is free of particles and without presence of corrosion on the surface, while the active material (Li(NiMnCo)_{1/3}O₂) of the positive electrode is intact and remains completely present on the aluminium surface (FIG. 4). In the filter, the carbon powder, which can be easily recovered by sieving, is observed.

### Example 5: Selective Peeling of Graphite from a Mixture of Electrodes in an Aqueous Medium Under Stirring and Ultrasonic Activation

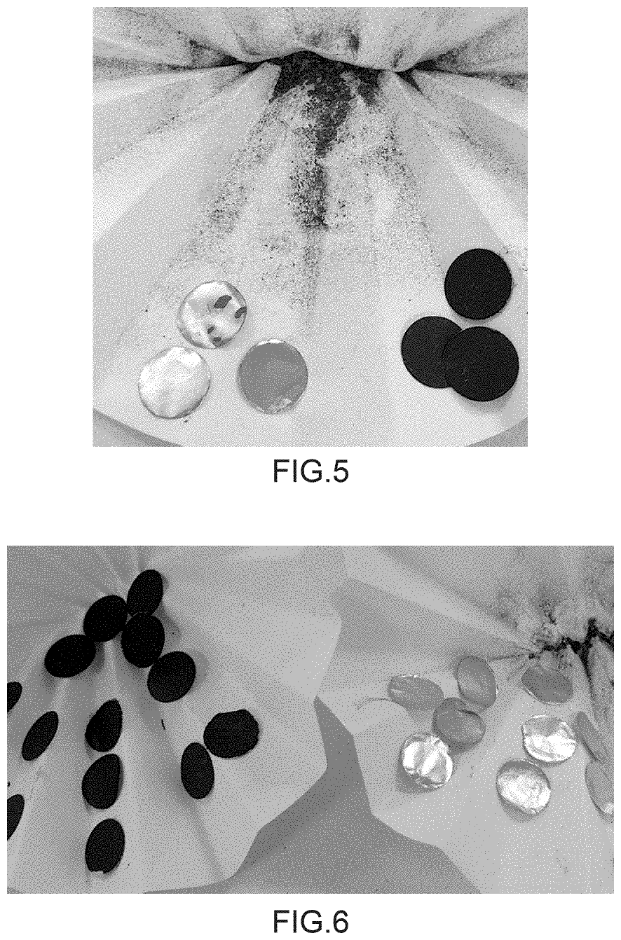

A CATL prismatic Li-ion type cell is previously discharged, opened then dried. The positive electrode, formed of an aluminium collector and NMC-type active materials in an NCA mixture, and the negative graphite electrode are removed manually. Then, three pads of each electrode are prepared. The separation solution (5 mL) is an aqueous solution having a pH between 6 and 7, at a temperature of 30° C. The solution is stirred at 200 rpm. The six pads are immersed in the solution then a 23 KHz ultrasound probe is actuated at 20% of its power continuously. After 5 minutes of treatment, graphite is peeled from the negative electrode. The copper is free of particles and without presence of corrosion on the surface. The active material of the positive electrode is intact and remains completely present on the aluminium surface (black pads). After filtration, the carbon powder, which can be easily recovered by sieving, is observed in the filter (FIG. 5).

### Example 6: Selective Peeling of Graphite from a Mixture of Electrodes in an Aqueous Medium Under Stirring and Ultrasonic Activation

A CATL prismatic Li-ion type cell is previously discharged, opened then dried. The positive electrode, formed of an aluminium collector and NMC-type active materials in an NCA mixture, and the negative graphite electrode are removed manually. Then, fifteen 12 mm pads of each electrode are prepared. The separation solution (30 mL) is an aqueous solution having a pH between 6 and 7, at a temperature of 30° C. The solution is stirred at 200 rpm. The pads are immersed in the solution then a 23 KHz ultrasound probe is operated at 20% of its power continuously. After five minutes of treatment, graphite is peeled from the negative electrode. The copper is free of particles and without presence of corrosion on the surface. The active material of the positive electrode is intact and remains completely present on the aluminium surface (black pads). After filtration, the carbon powder, which can be easily recovered by sieving, is observed in the filter (FIG. 6).

What is claimed is:

1.-14. (canceled)

15. A method for selectively separating a carbon-containing material from a mixture comprising a positive electrode and a negative electrode originating from electrochemical cells or accumulators, the method comprising the following successive steps:
a) providing a mixture comprising a positive electrode and a negative electrode, each electrode comprising a current collector, an active material and a binder, the active material of the negative electrode being a carbon-containing material,
b) contacting the mixture comprising the positive electrode and the negative electrode with a separation solution, in the presence of ultrasound, the separation solution comprising a solvent, until selectively separating the carbon-containing material from the current collector of the negative electrode, the active material of the positive electrode remaining secured to the current collector of the positive electrode.

16. The method according to claim 15, wherein the solvent is water.

17. The method according to claim 15, wherein the solvent is an alcohol.

18. The method according to claim 15, wherein the solution is an ionic liquid solution comprising a solvent ionic liquid.

19. The method according to claim 18, wherein the solvent ionic liquid comprises a cation and an anion, the cation being selected from one of the following families: imidazolium, pyrrolidinium, ammonium, piperidinium and phosphonium and the anion being selected from halides, bis(trifluoromethanesulfonyl)imide (CF₃SO₂)₂N⁻, bis(fluorosulfonyl)imide (FSO₂)₂N⁻, trifluoromethanesulfonate, tris(pentafluoroethyl)trifluorophosphate and bis(oxalato)borate anions.

20. The method according to claim 19, wherein the anion is a chloride, in combination with an ammonium or phosphonium cation.

21. The method according to claim 20, wherein the solvent ionic liquid is trihexyltetradecylphosphonium chloride ([P66614][Cl]).

22. The method according to claim 18, wherein the ionic liquid solution forms a deep eutectic solvent.

23. The method according to claim 22, wherein the deep eutectic solvent is a mixture of choline chloride and ethylene glycol.

24. The method according to claim 15, wherein step b) is carried out at a temperature ranging from 20° C. to 80° C.

25. The method according to claim 15, wherein step b) is carried out for a period ranging from 1 min to 30 min.

26. The method according to claim 15, wherein the separation solution contains additives, the additives being flotation agents selected from kerosene, n-dodecane and methyl isobutyl carbinol.

27. The method according to claim 15, wherein the ultrasound frequency is between 16 KHz and 500 KHz per litre of separation solution.

28. The method according to claim 15, wherein the power ranges from 0.01 kW/m³/h to 10 kW/m³/h of separation solution.

29. The method according to claim 15, wherein the ratio between the total mass of positive electrode and negative electrode to the volume of separation solution is comprised between 0.1 g/L and 50 g/L.

30. The method according to claim 15, wherein the separation solution further comprises additives.

31. The method according to claim 15, wherein the active material of the negative electrode is graphite.

32. A method for recycling a battery comprising the following successive steps:
providing a battery, comprising an organic electrolyte, a positive electrode and a negative electrode, each electrode comprising a current collector, an active material and a binder, the active material of the negative electrode being a carbon-containing material,
dismantling, securing and cutting the battery, so as to obtain a mixture comprising an organic electrolyte, a positive electrode and a negative electrode,
washing the mixture in a solution, in the presence of ultrasound, so as to remove the organic electrolyte from the positive electrode and the negative electrode and to selectively separate the carbon-containing material from the current collector of the negative electrode, the active material of the positive electrode remaining secured to the current collector of the positive electrode.

33. The method according to claim 32, wherein the active material of the negative electrode is graphite.
